(19) United States
(12) Patent Application Publication
(10) Pub. No.: US 2011/0297767 A1
(43) Pub. Date: Dec. 8, 2011

(54) ONE-WAY DRIVING MECHANISM FOR THE PAPER REMOVAL DEVICE OF A SHREDDER

(75) Inventor: Jia-Wang JIANG, NingBo City (CN)

(73) Assignee: Michilin Prosperity Co., Ltd., SanChung City (TW)

(21) Appl. No.: 13/092,437

(22) Filed: Apr. 22, 2011

(30) Foreign Application Priority Data
Jun. 2, 2010 (TW) 099210447

(51) Int. Cl. B02C 18/22; B02C 18/24

(52) U.S. Cl. 241/34; 241/37.5

(57) ABSTRACT

A one-way driving mechanism for the paper removal device of a shredder is disclosed. A transmission gear set is disposed between the cutting blades and paper-feeding wheels of the shredder. The primary gear of the transmission gear set is mounted on the rotary shaft of the cutting blades. The primary gear has at least one interference element. When the rotary shaft rotates in the shredding direction, the interference element connects and rotates with the end part of the rotary shaft. When the rotary shaft rotates in the reverse direction, the interference element is separate from the end part of the rotary shaft. This ensures that the paper-feeding wheels remain static in the REV mode.

### BACKGROUND OF THE INVENTION

1. Field of Invention

The invention relates to a shredder and, in particular, to a one-way driving mechanism for the paper-removal device of a shredder.

2. Related Art

According to the cutting methods, shredders can be classified as stripe-cut shredders that cut paper into stripes and cross-cut shredders that cut paper into chips.

The shredding head of the stripe-cut shredder can be used independently. The shredding head of the cross-cut shredder must be accompanied with a trash bin. The reason is that the lower part of the shredding head of the cross-cut shredder is an open paper outlet. When the shredding head and the trash bin are separate, its user may hurt himself by putting his hand into the paper outlet and getting cut by the running blades. To prevent this, the shredding head of the cross-cut shredder has to have a safety switch and the trash bin is usually provided with a protruding block corresponding to the switch. When the shredding head and the trash bin are combined, the protruding block urges against the safety switch so that the shredder is power-on and can run normally. When the shredding head and the trash bin are separate, the protruding block leaves the safety switch so that the safety switch automatically turns off the power for the shredder. In this case, the blades will not hurt the user even if he puts his hand into the paper outlet.

The shredding head of the cross-cut shredder is restricted to be equipped with a special trash bin and cannot be used along. Therefore, the production and distribution costs of the cross-cut shredders are still relatively high.

To prevent the user from being hurt by putting hands into the paper inlet of the cross-cut shredder, the shredder disclosed in PROC Pat. No. 200610052985.8 uses a paper-feeding mechanism under the paper inlet. The paper-feeding mechanism is basically a paper-feeding wheel that rotates with the cutting blades. With the shielding effect of the paper-feeding wheel at the paper inlet, the user's hand will not touch the cutting blades even if it is inserted into the paper inlet. This guarantees the safety, At the same time, the paper chips produced by the cutting blades can readily fall into the trash bin with the help of the paper-feeding wheel.

When the shredder is in the shredding mode, the paper-feeding mechanism functions with the rotation of the cutting blades. It indeed has a shielding effect and achieves the goal of removing paper chips. However, when the shredder is in the reverse mode, the paper-feeding wheel should be stationary. Otherwise, the reversed paper chips or paper that is not completely shredded may be jammed, affecting the normal functioning of the shredder.

### SUMMARY OF THE INVENTION

In view of the foregoing, the invention provides a one-way driving mechanism for the paper removal device of a shredder. A transmission gear set is disposed between the cutting blades and paper-feeding wheels of the shredder. The primary gear of the transmission gear set is mounted on the rotary shaft of the cutting blades. The primary gear has at least one interference element. When the rotary shaft rotates in the shredding direction, the interference element connects and rotates with the end part of the rotary shaft. When the rotary shaft rotates in the reverse direction, the interference element is separate from the end part of the rotary shaft. This ensures that the paper-feeding wheels remain static in the reverse (REV) mode.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 is a three-dimensional perspective view of the disclosed shredding head;

FIG. 2 is a three-dimensional perspective view of the disclosed paper-feeding wheels;

FIG, 3 is a side view showing the structure of the one-way driving mechanism;

FIG. 4 is a schematic view of the primary gear rotating with the rotary shaft;

FIG. 5 is a schematic view of the primary gear not rotating with the rotary shaft; and

FIG. 6 shows the relative positions of the cutting blades and the paper-feeding wheels.

### DETAILED DESCRIPTION OF THE INVENTION

The present invention will be apparent from the following detailed description, which proceeds with reference to the accompanying drawings, wherein the same references relate to the same elements.

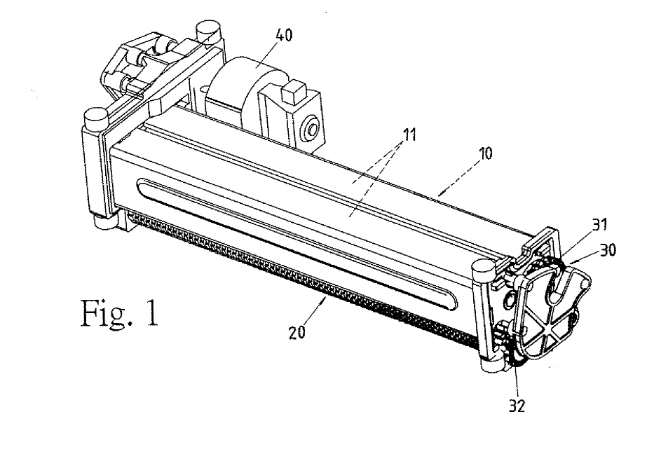

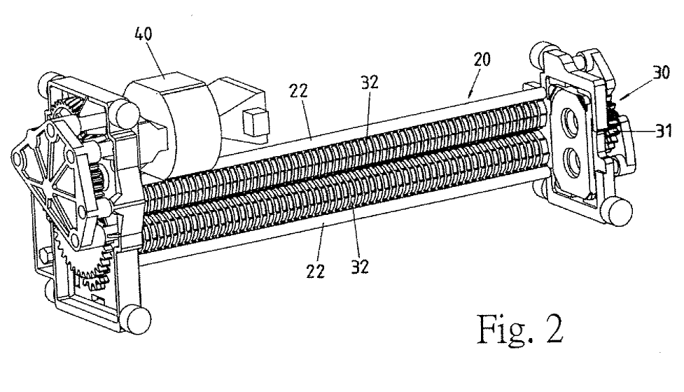

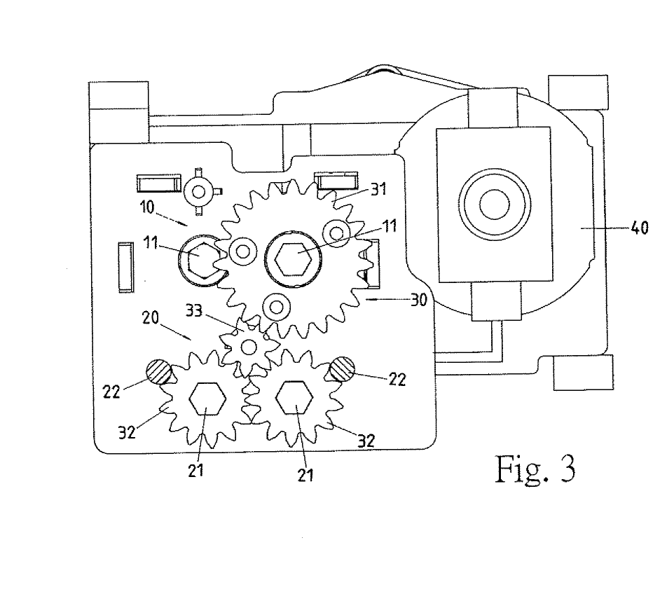

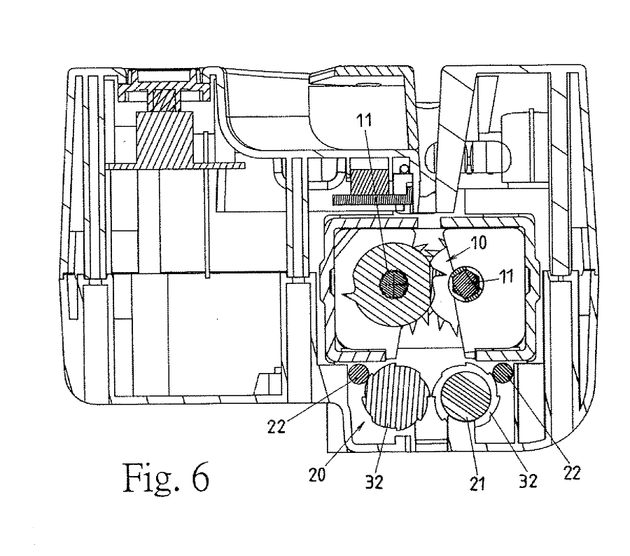

FIG. 1 is a three-dimensional perspective view of the disclosed shredding head. FIG. 2 is a three-dimensional perspective view of the disclosed paper-feeding wheels. FIG. 6 shows the relative positions of the cutting blades and the paper-feeding wheels.

The disclosed one-way driving mechanism for the paper removal device of a shredder includes: cutting blades 10, paper-feeding wheels 20, and a transmission gear set 30.

The cutting blades 10 are provided at the paper inlet of the shredding head. There are two rotary shafts 11, each of which is equipped with blades of a specific type (not shown). Driven by a motor 40, the cutting blades 10 cut the paper passing through the rotary shafts 11.

The paper-feeding wheels 20 are provided at the paper outlet of the shredding head. It has at least two paper-feeding wheel shafts 21 that have a shielding effect at the paper outlet. They prevent the user from putting his hand into the running blades and getting hurt.

In practice, the paper-feeding wheels 20 are provided with two auxiliary wheel shafts 22 on the outer sides of the two paper-feeding wheel shafts 21 to enhance the paper removal effect.

FIG. 3 shows the transmission relation between the cutting blades 10 and the paper-feeding wheels 20 due to the transmission gear set 30. One end of the rotary shaft 11 of the cutting blades 10 is fixed with a primary gear 31. The two wheel shafts 21 of the paper-feeding wheels 20 are provided with secondary gears 32, respectively. At least one speed-changing gear 33 is interposed between the primary gear 31 and the two secondary gears 32.

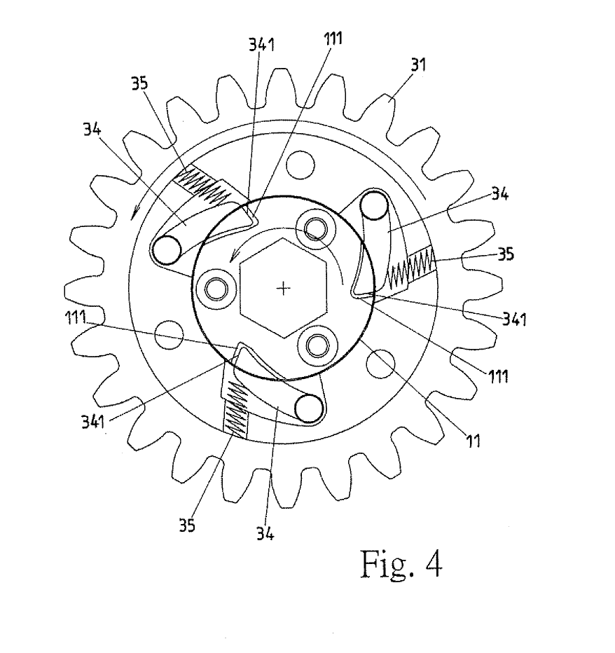

Please refer to FIG. 4. The transmission gear set 30 has at least one interference element 34 between the primary gear 31 and the rotary shaft 11. One end of each interference element 34 is pivotally mounted on the primary gear 31. Its other end has a positioning pin 341. The upper end of any positioning pin 341 has an elastic element 35 so that the positioning pin 341 is constantly pushed toward the rotary shaft 11. Moreover, the rotary shaft 11 has an internal element with an equal number of recesses 111 as the interference element 34 on its end portion. When the positioning pins 341 of the interference elements 34 engage with the recesses 111 of the internal element, the primary gear 31 rotates with the rotary shaft.

The so-called one-way driving mechanism is as shown in FIG. 4. When the rotary shaft 11 and the positioning pins 341 of the interference elements 34 rotate in opposite directions (i.e., opposite to the shredding direction, AUTO, of the rotary shaft), the positioning pins 341 of the interference elements 34 engage with the recesses 111 of the internal element under the action of the elastic element 35. The primary gear 31 of the transmission gear set 30 thus rotates with the rotary shaft 11. This in turn drives the paper-feeding wheels 20 to rotate concurrently. The paper chips can be smoothly sent downward to the trash bin, achieving the goal of paper removal.

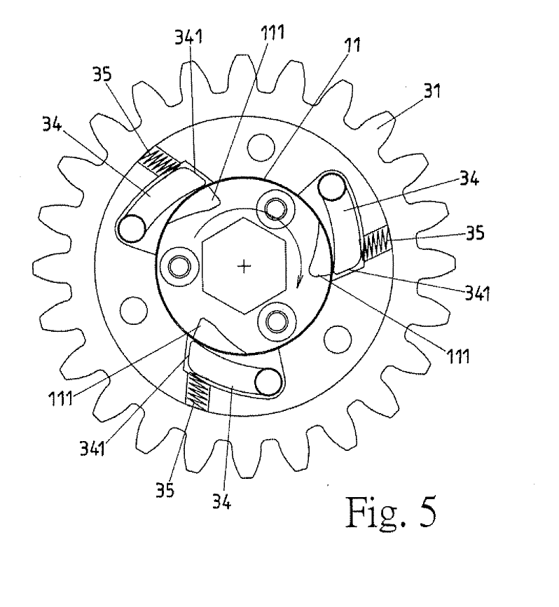

On the other hand, as shown in FIG. 5, when the rotary shaft 11 and the positioning pins 241 of the interference elements 34 rotate in the same direction (the reverse direction, REV, of the rotary shaft), the positioning pins 341 of the interference elements 34 are separate from the recesses 111 of the internal element. That is, the positioning pins 341 of the interference element 34 are pushed out of the recesses 111 by the internal element rotating in the reverse direction. The primary gear 31 of the transmission gear set 30 loses the driving force from the rotary shaft 11. As a result, the paper-feeding wheels 20 remain static.

With the above-described design, the paper removal device of the shredder in the AUTO mode removes paper chips into the trash bin as the rotary shaft rotates. In the REV mode of the shredder, the paper removal device does not rotate with the rotary shaft but remains static. This can effectively prevent the user from hurting his fingers.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A one-way driving mechanism for the paper removal device of a shredder, comprising:
cutting blades having at least two rotary shafts;
paper-feeding wheels having at least two paper-feeding wheel shafts;
a transmission gear set with a primary gear mounted on one rotary shaft of the cutting blades and secondary gears mounted on the two paper-feeding wheel shafts;
wherein the primary gear has at least one interference element, the interference element connects and moves with an end portion of the corresponding rotary shaft when the cutting blades rotate in the direction of shredding paper, and the interference element is separate from the end portion of the rotary shaft when the cutting blades rotate in the reverse direction.

2. A one-way driving mechanism for the paper removal device of a shredder as in claim 1, wherein the primary gear and the two secondary gears are interposed with at least one speed-changing gear.

3. A one-way driving mechanism for the paper removal device of a shredder as in claim 1, wherein one end of the interference element is mounted on the primary gear and the other end has a positioning pin, and an elastic element is provided on the top end of the positioning pin so that the positioning pin is constantly pushed toward the rotary shaft.

4. A one-way driving mechanism for the paper removal device of a shredder as in claim 1, wherein the end portion of the rotary shaft has an internal element with the same number of recesses as the interference elements.

5. A one-way driving mechanism for the paper removal device of a shredder as in claim 1, wherein when the rotary shaft and the positioning pins of the interference elements rotate in opposite directions (the shredding direction of the rotary shaft), the positioning pins of the interference elements engage with the recesses due to the elastic element, so that the primary gear of the transmission gear set rotates with the rotary shaft.

6. A one-way driving mechanism for the paper removal device of a shredder as in claim 1, wherein when the rotary shaft and the positioning pins of the interference elements rotate in the same direction (the reverse direction of the rotary shaft), the positioning pins of the interference elements are pushed out of the recesses to become separate by the internal element rotating in the reverse direction, so that the primary gear of the transmission gear set does not rotate with the rotary shaft.

7. A one-way driving mechanism for the paper removal device of a shredder as in claim 1, wherein the primary gear and the two secondary gears are interposed with at least one speed-changing gear.
